(19) United States
(12) Patent Application Publication
(10) Pub. No.: US 2026/0352423 A1
(43) Pub. Date: Nov. 5, 2026

(54) Defining a Block Acknowledgement (BA) Buffer Size of a BA Agreement During a Seamless Roaming Procedure

(71) Applicant: NXP USA, Inc., AUSTIN, TX (US)

(72) Inventors: Liwen Chu, San Ramon, CA (US); Huizhao Wang, San Jose, CA (US); Hongyuan Zhang, Fremont, CA (US); Kiseon Ryu, San Diego, CA (US); Ken Kinwah Ho, San Jose, CA (US)

(21) Appl. No.: 19/741,154

(22) Filed: Jul. 14, 2026

Related U.S. Application Data
(63) Continuation-in-part of application No. 19/338,485, filed on Sep. 24, 2025.
(60) Provisional application No. 63/843,922, filed on Jul. 14, 2025.
(60) Provisional application No. 63/698,533, filed on Sep. 24, 2024.
(60) Provisional application No. 63/775,621, filed on Mar. 21, 2025.
(60) Provisional application No. 63/801,690, filed on May 7, 2025.

(51) Int. Cl. H04L 5/00; H04L 1/00; H04W 28/02; H04W 28/18

(52) U.S. Cl. CPC H04L 5/0055; H04L 1/0057; H04W 28/0215; H04W 28/18

(57) ABSTRACT

Seamless roaming by a non-access point multi-link device (non-AP MLD) in a seamless mobile domain (SMD) of a wireless network from a serving AP MLD to the target AP MLD comprises determining, based on a transmit buffer size capability of the target AP MLD relative to a negotiated BA buffer size of a downlink (DL) BA agreement, whether to negotiate with the non-AP MLD a BA buffer size for a DL BA agreement with the target AP MLD, and determining, based on a reorder buffer size capability of the target AP MLD relative to a negotiated BA buffer size of a UL BA agreement, whether to negotiate with the non-AP MLD a BA buffer size for an UL BA agreement with the target AP MLD.

### CROSS-REFERENCE TO RELATED APPLICATIONS

This application claims the benefit of U.S. Provisional Patent Application Serial Number 63/843922 entitled “ROAMING TBDS - BA CAPABILITY AND BA OPERATION UNDER”, filed Jul. 14, 2025 and is a continuation in part of U.S. Patent Application Serial Number 19/338485 entitled “SYSTEM AND METHOD FOR WIRELESS ROAMING RESOURCE RESERVATION OR NEGOTIATION” filed Sept. 24, 2025 which claims the benefit of U.S. Provisional Patent Application Serial Number 63/698,533, filed Sept. 24, 2024, U.S. Provisional Patent Application Serial Number 63/775,621, filed Mar. 21, 2025, and U.S. Provisional Patent Application Serial Number 63/801,690, filed May 7, 2025, the contents each of which are incorporated by reference herein in their entireties.

### FIELD

The present disclosure relates to wireless communications and, more particularly, to defining a block acknowledgment (BA) buffer size of a BA agreement during seamless roaming when a non-access point multi-link device (non-AP MLD) roams from a serving access point multi-link device (AP MLD) to a target AP MLD within a seamless roaming domain.

### BACKGROUND

In a seamless mobile domain (SMD), access point multi-link devices (AP MLDs) positioned at different locations in a wireless network allow a non-access point multi-link device (non-AP MLD) to roam from a serving AP MLD to a target AP MLD without disassociation and reassociation with the SMD. During such seamless roaming, frame exchanges continue with the serving AP MLD based on the existing association with the SMD while links are established with the target AP MLD and data frame exchanges transition from the serving AP MLD to the target AP MLD.

The serving AP MLD and the target AP MLD each have a respective transmit buffer which store frames to transmit to a non-AP MLD in a downlink direction. The non-AP MLD which exchanges frames with an AP MLD further has a receiving-side reorder buffer to receive transmitted frames and to reorder the transmitted frames to be provided to upper layers of the AP MLD. Block Ack (BA) agreements are used to acknowledge data frames exchanged in the wireless network. The non-AP MLD further generates a BA bitmap which indicates received frames from the AP MLD associated with the BA agreement. The BA bitmap is transmitted to the AP MLD as a BA to acknowledge the received frames. The non-AP MLD also has a transmit buffer and the serving AP MLD, and target AP MLD also have a respective reorder buffer to allow for the non-AP MLD to transmit frames in an uplink direction which is received by one of the serving AP MLD or target AP MLD.

### BRIEF DESCRIPTION OF DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates an example seamless roaming in a seamless mobile domain (SMD) of a multi-link wireless communications system in accordance with one or more embodiments.

FIG. 2 illustrates an example buffer control by a non-AP MLD and AP MLD of the seamless mobile domain (SMD) in accordance with one or more embodiments.

FIG. 3A and 3B illustrate an example of whether to negotiate a DL BA buffer size and how to negotiate the DL BA buffer size during the seamless roaming stage and downlink frame communication to a non-AP MLD within and after the DL frame draining stage in a seamless roaming domain (SMD) having a serving AP MLD and the target AP MLD in accordance with one or more embodiments.

FIG. 4 illustrates example of whether to negotiate a UL BA buffer size and how to negotiate the UL BA buffer size during the seamless roaming stage and uplink frame communication to the AP MLD after the DL draining stage in a seamless roaming domain (SMD) having a serving AP MLD and the target AP MLD in accordance with one or more embodiments.

FIG. 5 illustrates a flowchart of functions associated with managing a BA buffer size negotiation during seamless roaming from a serving access point multi-link device (AP MLD) to a target AP MLD and downlink communication in accordance with one or more embodiments.

FIG. 6 illustrates a flowchart of functions associated with managing a BA buffer size during seamless roaming from a serving access point multi-link device (AP MLD) to a target AP MLD and uplink communication in accordance with one or more embodiments.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “an example”, or similar language means that a particular feature, structure, or characteristic described in connection with the indicated embodiment is included in at least one embodiment of the present invention. Thus, the phrases “in one embodiment”, “in an embodiment”, “an example”, and similar language throughout this specification may, but do not necessarily, all refer to the same embodiment.

Several aspects of the disclosed WiFi system will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

An access point (AP) multi-link device (MLD) has a transmit buffer size and a non-AP MLD has a reorder buffer size to support a BA agreement for transmission of downlink data frames with a traffic identifier (TID). The transmit buffer size of the AP MLD and reorder buffer size of the non-AP MLD for the downlink (DL) transmission are defined by a block acknowledgment (BA) buffer size negotiated by a BA agreement negotiation. Further, an access point (AP) multi-link device (MLD) has a reorder buffer size and a non-AP MLD has a transmit buffer size to support a BA agreement for transmission of uplink data frames with a TID. The transmit buffer size of the non-AP MLD and reorder buffer size of the AP MLD for the uplink (UL) transmission are defined by a block acknowledgment (BA) buffer size negotiated by the BA agreement negotiation. Conventional seamless roaming operation does not adequately address adjustment of the BA buffer size between a serving AP MLD and non-AP MLD when the non-AP MLD roams from the serving AP MLD to the target AP MLD in a seamless roaming domain (SMD).

Embodiments disclosed herein are directed to establishing by a target AP MLD a negotiated BA buffer size for frame exchanges of a BA agreement with a non-AP MLD in a seamless roaming domain (SMD) having a serving AP MLD and the target AP MLD. In an embodiment, the AP MLDs in the SMD have a same BA buffer size capability. In an embodiment, the AP MLDs in a SMD have different BA buffer size capabilities and the BA buffer size capabilities of the AP MLDs in the SMD are mapped to a same BA bitmap size. In an embodiment, the AP MLDs in a SMD have different BA buffer size capabilities and the BA buffer size capabilities of the AP MLDs in the SMD are mapped to different BA bitmap sizes. During roaming by a non-AP MLD from the serving AP MLD to the target AP MLD, a negotiated BA buffer size of a DL BA agreement (BA agreement for DL data frames for a TID) for each required DL TID with the target AP MLD is negotiated according to a transmit buffer size capability of the target AP MLD. The negotiated BA buffer size defines a size of the transmit buffer of the target AP MLD, a scoreboard context of the non-AP MLD (e.g., BA bitmap) and reorder buffer of the non-AP MLD. In an embodiment, in a downlink (DL) direction when the target AP MLD has a transmit buffer size capability smaller than a BA buffer size of a BA agreement of the serving AP MLD, the target AP MLD negotiates a smaller BA buffer size during the roaming than a negotiated BA buffer size of the BA agreement of the serving AP MLD. In an embodiment, in a downlink direction when the target AP MLD has a transmit buffer size capability the same as a BA buffer size of a BA agreement of the serving AP MLD, the target AP MLD uses the negotiated BA buffer size of the BA agreement of the serving AP MLD , i.e., the BA agreement doesn’t change after the roaming. In an embodiment, in a downlink direction when the target AP MLD has a transmit buffer size capability larger than a negotiated BA buffer size of a BA agreement of the serving AP MLD, the target AP MLD uses the negotiated BA buffer size of the BA agreement of the serving AP MLD. In an embodiment, in a downlink direction when the target AP MLD has a transmit buffer size capability larger than a BA buffer size of a BA agreement of the serving AP MLD, the target AP MLD alternatively negotiates during the roaming a larger BA buffer size for the BA agreement than a BA buffer size of a negotiated BA agreement of the serving AP MLD where the negotiated BA buffer sizes of the two AP MLDs are mapped to the same BA bitmap size. In an embodiment, in a downlink direction when the target AP MLD has a transmit buffer size capability larger than a BA buffer size of a BA agreement of the serving AP MLD, the target AP MLD negotiates during the roaming a larger BA buffer size for the BA agreement than a negotiated BA buffer size of a BA agreement of the serving AP MLD where the BA buffer sizes of the two AP MLDs can be mapped to the different BA bitmap sizes. When the new BA agreement is negotiated for a DL TID, the negotiated BA agreement with the serving AP MLD (old BA agreement) is used during the roaming and before the DL draining stage. In some embodiments, the target AP MLD is not allowed to transmit the DL data frames by using the DL BA agreement with the serving AP MLD during the downlink (DL) frame draining stage after seamless roaming stage, i.e. after the last management frame exchange for roaming negotiation, if the target AP MLD is not able to support the BA bitmap size being mapped by the negotiated BA buffer size of the BA agreement of the serving AP MLD. In some embodiments, the target AP MLD is allowed to transmit the DL data frames by using the DL BA agreement with the target AP MLD during the downlink (DL) frame draining stage after seamless roaming stage, i.e. after the last management frame exchange for roaming negotiation, if the target AP MLD is not able to support the BA bitmap size being mapped by the BA buffer size of the negotiated BA agreement of the serving AP MLD. In some embodiment, the target AP MLD is not allowed to transmit the DL data frames of a DL BA agreement during the downlink (DL) frame draining stage after the last management frame exchange for roaming negotiation if the target AP MLD is not able to transmit the DL data frames using the BA agreement of the serving AP MLD. In some embodiments, the target AP MLD and serving AP MLD transmit DL frames to the non-AP MLD based on the BA buffer size of the BA agreement of the serving AP MLD during the downlink (DL) frame draining stage after seamless roaming stage, i.e. after the last management frame exchange for roaming negotiation. In some embodiments, the target AP MLD transmits DL frames to the non-AP MLD based on the negotiated BA buffer size of the BA agreement of the target AP MLD during the downlink (DL) frame draining stage after seamless roaming stage, i.e. after the last management frame exchange for roaming negotiation. In an embodiment, in an uplink (UL) direction when the target AP MLD has a reorder buffer size capability smaller than a BA buffer size of a BA agreement of the serving AP MLD, the target AP MLD negotiates during the roaming a smaller BA buffer size for the BA agreement than the BA buffer size of the BA agreement of the serving AP MLD. In an embodiment, in an uplink (UL) direction when the target AP MLD has a reorder buffer size capability the same as a negotiated BA buffer size of a BA agreement of the serving AP MLD, the target AP MLD uses the negotiated BA agreement of the serving AP MLD, i.e. the BA agreement doesn’t change after the roaming. In an embodiment, in a UL direction when the target AP MLD has a reorder buffer size capability larger than a negotiated BA buffer size of a BA agreement of the serving AP MLD, the target AP MLD uses the negotiated BA buffer size of the BA agreement of the serving AP MLD. In an embodiment, in a UL direction when the target AP MLD has a reorder buffer size capability larger than a negotiated BA buffer size of a BA agreement of the serving AP MLD, the target AP MLD alternatively negotiates during the roaming a larger BA buffer size for the BA agreement than a BA buffer size of a BA agreement of the serving AP MLD. In an embodiment, in a UL direction when the target AP MLD has a reorder buffer size capability larger than a negotiated BA buffer size of a BA agreement of the serving AP MLD and smaller than a requested BA buffer size by the non-AP MLD to the serving AP MLD, the target AP MLD alternatively negotiates during the roaming a BA buffer size for the BA agreement same as the requested BA buffer size by the non-AP MLD to the serving AP MLD. In an embodiment, in a UL direction when the target AP MLD has a reorder buffer size capability larger than a BA buffer size of a BA agreement of the serving AP MLD, the target AP MLD uses the BA agreement of the serving AP MLD, and notifies its larger reorder buffer size capability. With such notification, the non-AP MLD can negotiate a new UL BA agreement after the roaming. After the DL drain period, the target AP MLD receives UL frames from the non-AP MLD based on the BA buffer size of the target AP MLD’s negotiation unless when the target AP MLD’s negotiation is not performed the target AP MLD receives UL frames from the non-AP MLD based on the BA buffer size of the serving AP MLD’s negotiation. Well known instructions, protocols, structures, and techniques have not been shown in detail in order not to obfuscate the description.

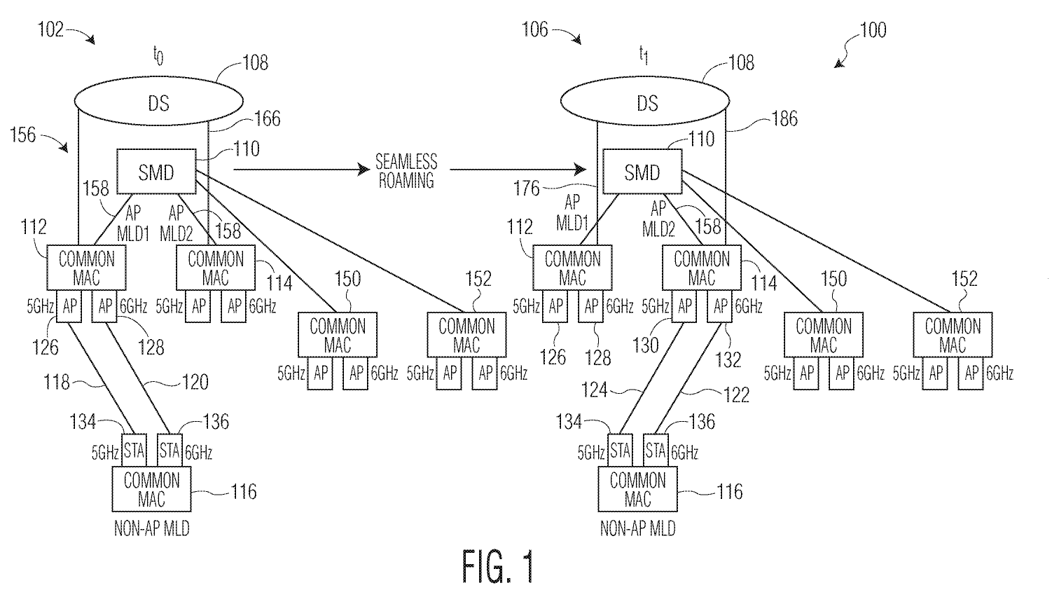

FIG. 1 illustrates an example of seamless roaming in a seamless mobile domain (SMD) of a multi-link wireless communications system in accordance with one or more embodiments. In the embodiment shown in FIG. 1, the multi-link communications system 100 includes a seamless mobile domain (SMD) 100 which includes a number of different affiliated AP MLDs 112, 114, 150, 152 in different physical locations that operate together and have a common medium access control (MAC) address to identify the SMD 110. The SMD 110 may exchange management information with a respective AP MLD via a respective management link 158. The multi-link communications system 100 also has multiple non-AP MLDs with an example of a non-AP station (STA) MLD (non-AP MLD) 116 which is able to wirelessly communicate with one AP MLD when roaming is done with one or more of the AP MLDs (during a roaming procedure). The AP MLDs 112, 114, 150 may be in a communication range of the non-AP MLD 116, while AP MLD 152 may not be in a communication range to the non-AP MLD 116. The multi-link communications system 100 may be used in various applications, such as industrial applications, medical applications, computer applications, and/or consumer or enterprise applications. In some embodiments, the multi-link communications system 100 may be a wireless communications system, such as a wireless communications system compatible with an Institute of Electrical and Electronics Engineers (IEEE) 802.11 protocol. For example, the multi-link communications system 100 may be a wireless communications system compatible with IEEE 802.11bn protocol and various other iterations of the 802.11 specification referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). A configuration of the multi-link communications system 100 is shown for different time instances t₀, t₁ while the non-AP MLD 116 performs a roaming between the neighbor AP MLDs of the seamless mobile domain 110.

The depicted multi-link wireless communications system 100 is shown with certain components and described with certain functionality herein, but the multi-link communications system 100 may include fewer or more components to implement the same, less, or more functionality. In some embodiments, the multi-link communications system 100 includes multiple associated non-AP MLDs. In some embodiments, an AP MLD may have a single affiliated AP. In some embodiments, a non-AP MLD may have a single affiliated STA. In some embodiments, the seamless mobile domain 110 may have more than four affiliated AP MLD or less than four affiliated AP MLD. In some embodiments, the non-AP MLD 116 may have a plurality of links to one or more respective AP MLDs to perform data communication. Although the multi-link communications system 100 is shown in FIG. 1 as being connected in a certain topology, the network topology of the multi-link communications system is not limited to the illustrated topology.

The seamless mobile domain 100 has AP MLD 112, AP MLD 114, AP MLD 150, AP MLD 152 which are collectively referred to herein as a distributed AP MLD group. In one or more embodiments, the distributed AP MLD group may be an extended service set (ESS) or part of an ESS. In some embodiment, some upper layer Media Access Control (MAC) functionalities (association, authentication, pairwise transient key (PTK) key negotiation, stream classification service (SCS) agreement, emergency preparedness communication service (EPCS) authorization, block acknowledgement (BA) agreement negotiation, MLD level power save of maximal idle period, etc.) are implemented in the seamless mobile domain 100. In some embodiments, some upper layer Media Access Control (MAC) functionalities (e.g., reordering of frames, STR/NSTR/MLSR/EMLSR, MLD level power save except maximal idle period, etc.) are implemented in a common MAC of an AP MLD 112, 114 and the APs of the AP MLDs implement lower layer MAC functionalities (e.g., backoff, frame transmission, frame reception, etc.). The seamless mobile domain 100 and associated components illustrated in FIG. 1 may be implemented in hardware (e.g., circuits), software, firmware, or a combination thereof and fully or partially implemented as an integrated circuit (IC) device.

In one or more embodiments, AP MLD 112 may have APs 126, 128, AP MLD 114 may have APs 130, 132, and AP MLD 150 and AP MLD 152 may also have corresponding APs. Those APs in a signal range may be neighbor APs. In embodiments, the APs may be wireless APs compatible with at least one WLAN communications protocol (e.g., at least one IEEE 802.11 protocol) and be implemented in hardware (e.g., circuits), software, firmware, or a combination thereof. The APs may be fully or partially implemented as an IC device and in some embodiments one or more APs may be virtual APs. In some embodiments, each physical AP includes at least one antenna, at least one transceiver operably connected to the at least one antenna, and at least one controller connected to the corresponding transceiver. In some embodiments, each AP affiliated with an AP MLD includes multiple RF chains and the at least one transceiver in a PHY circuit of the AP. The at least one controller may be configured to control the at least one transceiver to transmit and receive frames. In some embodiments, the at least one controller may be implemented within a processor, such as a microcontroller, a host processor, a host, a DSP, or a CPUs. In one or more embodiments, each of the APs may define different basic service set (BSS) operating channel operating in different frequency bands. The APs may operate in one of a 5 GHz or 6 GHz band. In one or more embodiments, the AP MLD 112 includes a 5 GHz AP 126 and 6 GHz AP 128. The AP MLD 114 includes a 5 GHz AP 130 and 6 GHz AP 132.

Each of AP MLDs 112, 114, 150, 152 may be further coupled to a distribution system (DS) 108 which could be an Ethernet switch or access server which facilitates data communication with a local area network (e.g., a LAN) or a backbone network (e.g., the Internet) through a respective wired connection such as connection 156, 166, 176, 186 respectively. The distribution system 108 may transmit or receive data frames between a LAN or backbone network (not shown) and one or both of the AP MLD 112, 114.

The non-AP MLD 116 includes two non-AP STAs 134, 136 which are implemented in hardware (e.g., circuits), software, firmware, or a combination thereof. The STAs 134, 136 may be fully or partially implemented as an IC device. In some embodiments, the STAs 134, 136 are part of the non-AP MLD 116, such that the non-AP MLD 116 may be a communications device that wirelessly connects to one or more AP MLD 112, 114. For example, the non-AP MLD 116 may be implemented in a laptop, a desktop personal computer (PC), a mobile phone, or other communications device that supports at least one WLAN communications protocol. In some embodiments, the non-AP MLD 116 implements MAC functionality which is divided between an MLD level common MAC functionality and the non-AP STAs 134, 136 implement lower layer MAC data functionality. In some embodiments, each STA includes at least one antenna, at least one transceiver operably connected to the at least one antenna, and at least one controller connected to the corresponding transceiver. In some embodiments, an STA affiliated with a non-AP MLD includes multiple RF chains and the at least one transceiver in a PHY circuit of the STA. The at least one controller may be configured to control the at least one transceiver to transmit and receive frames. In some embodiments, at least one controller may be implemented within a processor, such as a microcontroller, a host processor, a host, a DSP, or a CPU. The STAs may operate in one of a 5 GHz or 6 GHz band.

In one or more embodiments, the non-AP MLD 116 may set up an association with seamless mobile domain 110 through links 118, 120 of an AP MLD 112 affiliated with a seamless mobile domain 110 and referred to as the serving AP MLD 112 at time t₀. The links may be wireless connections between components of the multi-link communications system 100. The links facilitate uplink and downlink communication between the AP MLD 112 and the non-AP MLD 116 and each link defines a connection between an AP and non-AP. In an embodiment, the uplink communication is transmitting data/management frames from a non-AP MLD 116 to the AP MLD 112 referred to a serving AP MLD and the downlink communication is transmitting data/management frames from the serving AP MLD 112 to the non-AP MLD 116. At some later time t₁, the non-AP MLD 116 seamlessly roams to another AP MLD 114, identified as a target AP MLD. The non-AP MLD 116 terminates the links 118, 120 with the serving AP MLD 112 and establishes links 122, 124 with target AP MLD 114 and DS mapping to the target AP MLD 114 to perform the seamless roaming to the target AP MLD 114. In an embodiment, the uplink communication is communication from a non-AP MLD 116 to the target AP MLD 114 and the downlink communication is communication from the target AP MLD 114 to the non-AP MLD 116. The non-AP MLD 116 roams from the serving AP MLD 112 to the target AP MLD 114 without disassociation and reassociation with the seamless mobile domain 110 and a state 4 operation is maintained (class 3 frame exchanges such as data frames, management frames, and control frames are continued without reassociation). During the roaming period, the serving AP MLD 112 and the target AP MLD 114 transmit the DL frames to the non-AP MLD during a grace period (e.g., DL frame draining period) after which the roaming procedure is completed. The seamless mobile domain 110 with AP MLDs 112, 114 positioned at different physical locations of the multi-link communications system 100 facilitates seamless roaming by a non-AP MLD 116 within an area covered by the seamless mobile domain 110. Because the area covered is large, chance of the non-AP MLD 116 transitioning from an AP MLD of one seamless mobile domain to an AP MLD of another seamless mobile domain is reduced. The non-AP MLD 116 sets up the association with the seamless mobile domain 110 through the links of one AP MLD affiliated with the seamless mobile domain 110.

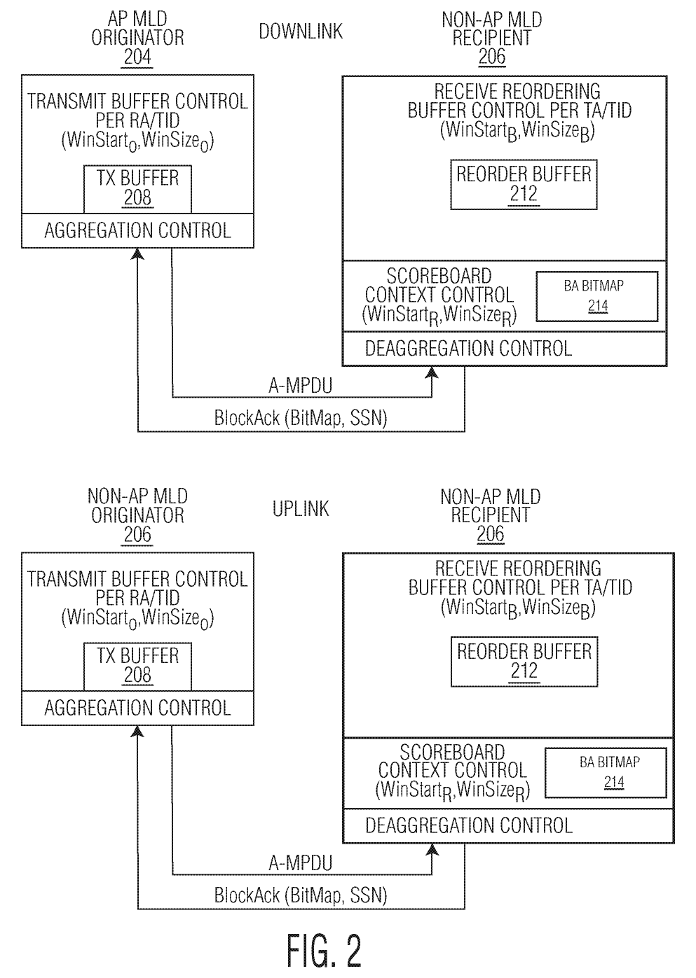

FIG. 2 illustrates an example of buffer control in the non-AP MLD and AP MLD of the seamless mobile domain (SMD) in accordance with one or more embodiments. An AP MLD 204 and non-AP MLD 206 may each be a respective originator and a respective recipient of data frames of a Block Ack (BA) agreement depending on whether the MLD is arranged to transmit or receive data frames of the BA agreement. A Block Ack (BA) agreement is an IEEE 802.11 wireless networking mechanism that improves channel efficiency. Instead of sending a separate acknowledgment (ACK) frame for every data frame associated with a traffic identifier (TID), two MLDs negotiate a BA agreement to acknowledge multiple data frames of the BA agreement simultaneously using a block acknowledgement control frame. In downlink (DL) communication 200, the AP MLD 204 may be the originator of a BA agreement for transmitting DL data frames of the BA agreement for a DL traffic identifier (TID) to the recipient of the BA agreement which is the non-AP MLD 206, while in uplink communication (UL) 202 the non-AP MLD 206 may be the originator of a BA agreement for transmitting UL data frames to the recipient which is the AP MLD 204.

In an embodiment, the data frames of a traffic identifier (TID) may have a sequence number (SN) space which in an embodiment ranges from 0 to 4095. The originator may have a transmit buffer control of a transmit buffer 208 for transmitting frames with a WinStartO and WinEndO (Context Window) which defines a specific "operating" or "order" window. WinStartO is the lowest sequence number of a transmitted frame the originator is currently waiting to have acknowledged. WinEndO is the highest allowed sequence number of a frame the originator can transmit. The recipient may have a receiver reordering buffer control of a receive reordering buffer 212 which stores received frames before being provided in order to upper layers of the AP MLD. WinstartB and WinEndB (defined by WinSizeB) (Reordering Buffer Window) may define a “reordering buffer window," representing the range of sequence numbers (SN) currently expected to be received at the recipient for sending to the up layer of the MAC layer sequentially. WinstartB indicates the lowest sequence number expected, while WinEndB indicates the highest sequence number in the reorder buffer expected. WinStartB is the sequence number of the first packet not yet received.

In one or more embodiments, the recipient may have a scoreboard context control. WinStartR and WinEndR (defined by WinSizeR) may define a scoreboard context which indicates frames which have been received and which an indication is to be transmitted to the originator via a BA control frame to indicate exactly which frames were successfully received. As data frames are received, the recipient may transmit the BA control frame to the originator which identifies whether the frames of the block acknowledgment agreement are correctly received or not by the scoreboard context control. The block acknowledgement BA control frame (specifically in 802.11 BlockAck) defines a BA bitmap 214 in a scoreboard buffer to efficiently acknowledge the reception of multiple frames, identifying which sequence numbers (SN) of frames were successfully received. The SN of a received frame is mapped to a unique bit in the BA bitmap 214 (i.e., scoreboard) to indicate whether the corresponding frame was correctly received. The BA bitmap 214 represents reception status of frames using bit positions in the bitmap mapped to unique sequence numbers of frames and a bit value (0/1) in a bit position indicates whether a frame having the sequence number associated with the bit position was received or not. The SN of the bitmap is interpreted by the originator based on a starting SN number (SSN) included in the BA control frame. In one embodiment, the serving AP MLD 302 and the target AP MLD 304 may transmit frames to the non-AP MLD 306 during the seamless roaming shown by communication 300. If required, the communication 300 may begin by negotiation of a DL BA agreement with the target AP MLD based on a transmit buffer size capability of the target AP MLD by using the management frames for the seamless roaming negotiation at 308 (seamless roaming preparation request, seamless roaming preparation response instead of seamless roaming execution request, seamless roaming execution response). During the seamless roaming negotiation at 308, only the serving AP MLD transmits the DL data frames of a BA agreement to the non-AP MLD. The negotiation of the DL BA agreement with the target AP MLD includes the BA request, e.g., the requested BA buffer size, from the AP MLD to the non-AP MLD followed by the BA response, e.g., the accepted BA buffer size, from the non-AP MLD to the target AP MLD. The BA request and BA response are carried in the management frames for the seamless roaming negotiation. Before the last management frame exchange for negotiating the seamless roaming of a non-AP MLD, the target AP MLD is not allowed to transmit the DL data frames to the non-AP MLD. In an embodiment, a transmit buffer size capability of the target AP MLD 304 may be a supported transmit buffer of the target AP MLD 304. The target AP MLD 304 may support a transmit buffer size that is smaller than the negotiated BA buffer size negotiated by the serving AP MLD 302 in a BA agreement. In a downlink (DL) direction when the target AP MLD 304 has a transmit buffer size smaller than a negotiated BA buffer size of a BA agreement of the serving AP MLD 302, the target AP MLD 304 negotiates the smaller BA buffer size than the negotiated BA buffer size of a BA agreement of the serving AP MLD 302 based on the BA agreement negotiation during the seamless roaming. In an embodiment, the negotiation of the BA agreement by the target AP MLD with the non-AP MLD is mandatory when the transmit buffer size supported is smaller than a BA buffer size of a BA agreement of the serving AP MLD 302. The negotiation may include the target AP MLD 304 announcing the smaller buffer size (BA request) and the non-AP MLD 306 accepting the smaller buffer size (BA response) as the negotiated BA buffer size with the target AP MLD for the DL BA agreement. In an embodiment, the seamless roaming stage is followed by a downlink (DL) frame draining stage, and during the seamless roaming stage the serving AP MLD 302 may deliver its DL data frames to the non-AP MLD 306. During the DL frame draining stage, the serving AP MLD 302 may deliver its DL data frames to the non-AP MLD 306, and the reorder buffer size of the BA agreement at the non-AP MLD does not change. That is, the reorder buffer size remains consistent with the BA agreement negotiated with the serving AP MLD 302. In one or more embodiments, the target AP MLD 304 transmits DL data frames of the BA agreement during the DL frame draining stage at 310 in the DL direction and receives a BA control frame where a bitmap size of the bitmap of the BA control frame is already defined by the negotiated BA agreement of the serving AP MLD 302 and the BA buffer size. In an embodiment, if the target AP MLD cannot use the negotiated BA agreement of the serving AP MLD 302 to transmit the DL data frames, the target AP MLD doesn’t transmit (shown by the dotted line 310) the DL data frames of the BA agreement during the DL frame draining stage. In an embodiment, if the negotiated BA buffer size of the target AP MLD is not mapped to the same BA bitmap size as the negotiated BA buffer size of the serving AP MLD, the target AP MLD doesn’t transmit (shown by the dotted line 310) the DL data frames of the BA agreement during the DL frame draining stage. After completion of the DL frame draining stage—when the non-AP MLD no longer receives DL frames from the serving AP MLD— a size of the reorder buffer at the non-AP MLD is updated at 354 to correspond to a BA buffer size negotiated with the target AP MLD. Further, the transmit buffer size of the target AP MLD is updated based on the BA buffer size of the negotiated BA agreement with the target AP MLD. The roaming is complete and the target AP MLD 304 is able to transmit frames to the non-AP MLD 306 at 314 by using the BA agreement negotiated by the target AP MLD and the non-AP MLD.

In an embodiment, a bitmap size of the bitmap 214 may be based on a BA buffer size of a BA agreement, e.g. <=64 BA buffer sizes are mapped to 64-bit bitmap, >64 and <=256 buffer sizes are mapped to 256-bit bitmap (where a BA buffer size is defined by a number of frames, >256 and <=512 buffer sizes are mapped to 512-bit bitmap, >512 and <=1024 buffer sizes are mapped to 1024-bit bitmap). The BA buffer size may be a result of a negotiated size of a BA buffer between an AP MLD and the non-AP MLD for a BA agreement which is the transmit buffer in the originator and the receive reorder buffer in the recipient corresponding to the BA agreement. In an embodiment, a reorder buffer may have a BA buffer size which is the BA buffer size and the transmit buffer may have a BA buffer size which is at least or greater than the BA buffer size based on a negotiation of the BA agreement. In the negotiation, the originator may send a request for a BA buffer size and the respondent may provide a response for the requested BA buffer size which the originator then uses as the BA buffer size. The recipient may keep track of the frames which were received in the reorder buffer 212 and send a BA control frame to the originator to acknowledge one or more frames in the reorder buffer 212 based on the BA agreement. In an embodiment, the AP MLD 204 may be an originator for a BA agreement for a downlink frame TID transmission to a non-AP MLD and the non-AP MLD 206 may be a recipient for the BA agreement. In an embodiment, the non-AP MLD 206 may be an originator for a BA agreement for an uplink frame TID transmission to an AP MLD 204 and the AP MLD 204 may be a recipient for the BA agreement.

In an embodiment, the AP MLDs in a SMD may have a same BA buffer size capability. The buffer size capability may be a supported buffer size by the AP MLDs and defined by a number of frames. In an embodiment, the AP MLDs in a SMD have different BA buffer size capabilities and the BA buffer sizes of the AP MLDs in the SMD are mapped to a same bitmap size, e.g. >64 and <=256 buffer sizes are mapped to 256-bit bitmap, >256 and <=512 buffer sizes are mapped to 512-bit bitmap, >512 and <=1024 BA buffer sizes are mapped to 1024-bit bitmap. In an embodiment, the AP MLDs in a SMD have different BA buffer size capabilities and the BA buffer sizes of the AP MLDs in the SMD are mapped to different bitmap sizes. An AP MLD and non-AP MLD may be capable of transmitting and receiving bitmaps of defined sizes. The BA buffer size may determine a size of the bitmap that the AP MLD or non-AP MLD is able to transmit or receive in the BA control frame.

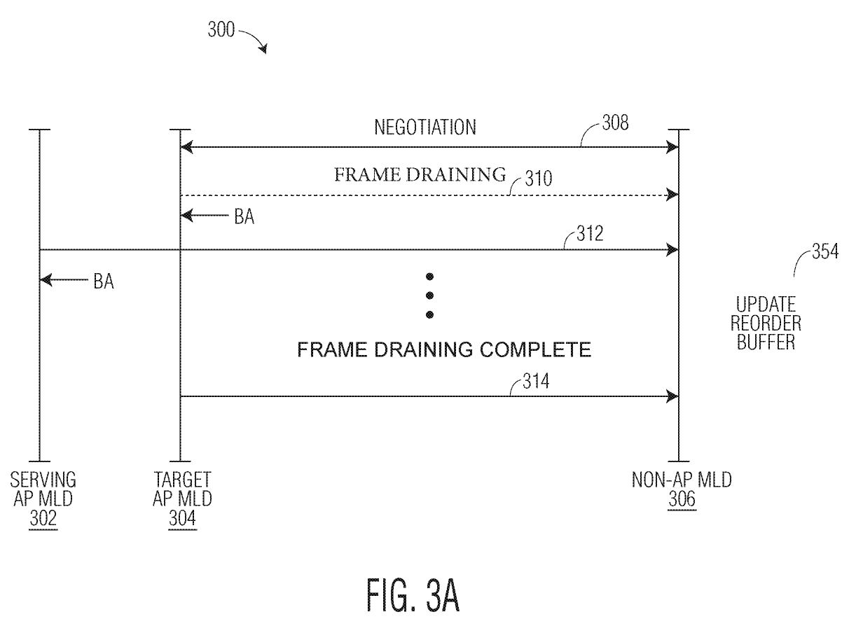

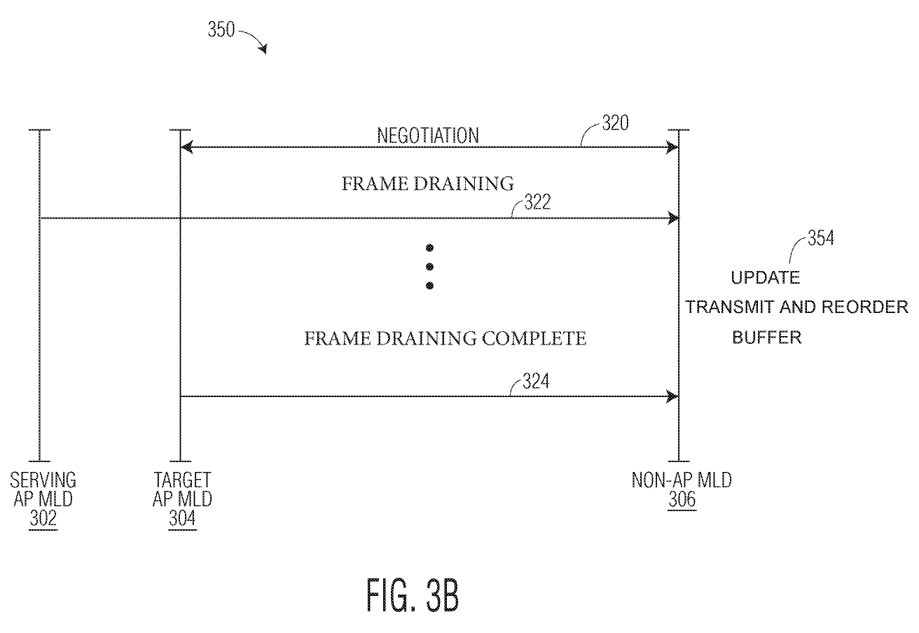

FIGS. 3A and 3B an example of whether to negotiate a DL BA buffer size and how to negotiate the DL BA buffer size during the seamless roaming stage and downlink frame communication to a non-AP MLD within and after the DL frame draining stage in a seamless roaming domain (SMD) having a serving AP MLD and the target AP MLD in accordance with one or more embodiments. The DL BA buffer size may be defined by a DL BA agreement of the target AP MLD. The non-access point multi-link device 306 (non-AP MLD) may perform roaming from the serving access point multi-link device 302 (AP MLD) to the target AP MLD 304. The communication may include the roaming stage (the handshakes through various management frames for roaming and within the grace period after a management frame exchange during a frame draining).

In another embodiment, the target AP MLD is not allowed to transmit frames of the BA agreement in the DL direction during the seamless roaming period but the serving AP MLD 302 transmits frames in the DL direction according to the BA agreement during the seamless roaming period shown by communication 350. At 320, a BA agreement is negotiated between the non-AP MLD 306 and the target AP MLD 304 during the seamless roaming period including negotiating a BA buffer size through the management frames for seamless roaming negotiation. The BA agreement of a TID of the DL data frames is negotiated through seamless roaming negotiation management frames. The target AP MLD sends the BA request (requested BA buffer size) to the non-AP MLD and the non-AP MLD sends the BA response (accepted BA buffer size) to the target AP MLD. The serving AP MLD 302 transmits frames at 322 during DL frame draining stage following the seamless roaming period but the target AP MLD 304 does not transmit frames during the DL frame draining stage following the seamless roaming period. Further, the serving AP MLD 302 receives a BA control frame with a bitmap size of the bitmap of the BA control frame being defined by the BA agreement of the serving AP MLD 302, i.e. the negotiated BA buffer size of the serving AP MLD 302. After completion of the DL frame draining stage—when the non-AP MLD no longer receives DL frames from the serving AP MLD— a size of the reorder buffer at the non-AP MLD is updated at 354 to correspond to a BA buffer size negotiated with the target AP MLD and the BA bitmap is updated based on the negotiated BA buffer size with the target AP MLD 304. Further, the transmit buffer size of the target AP MLD is updated based on the BA buffer size of the negotiated BA agreement with the target AP MLD. The target AP MLD 304 is then able to transmit DL frames to the non-AP MLD 306 at 324. In some embodiment, such restriction at the target AP MLD is applied when the target AP MLD is not able to support the BA bitmap size being mapped by the BA buffer size of the BA agreement of the serving AP MLD. In some embodiment, such restriction at the target AP MLD is applied when the target AP MLD is not able to transmit the DL data frames using the BA agreement of the serving AP MLD.

In one or more embodiments, the target AP MLD may support a transmit buffer size which is the same as the negotiated BA buffer size of a BA agreement of the serving AP MLD during the seamless roaming. The target AP MLD is not allowed to perform the BA agreement negotiation during the roaming stage. In some embodiments, during seamless roaming stage, the serving AP MLD transmits DL frames to the non-AP MLD while the target AP MLD is not allowed to transmit DL frames to the non-AP MLD. In some embodiments, during a downlink (DL) frame draining stage in which in-flight frames from the serving AP MLD are delivered to the non-AP MLD, the serving AP MLD and the target AP MLD transmit DL frames to the non-AP MLD. After completion of the DL frame draining stage, when the non-AP MLD no longer receives DL frames from the serving AP MLD, a reorder buffer size at the non-AP MLD is not further modified since a size of the reorder buffer at the non-AP MLD was already at least a BA buffer size of the serving AP MLD.

In one or more embodiments, the target AP MLD may support a transmit buffer size which is larger than a BA buffer size of a BA agreement of the serving AP MLD during the seamless roaming. The target AP MLD may negotiate with the non-AP MLD a larger BA buffer size than the BA buffer negotiated by the serving AP MLD. In some embodiments, the target AP MLD requests the BA buffer size for a DL BA agreement in a management frame transmitted by the target AP MLD to the non-AP MLD through the serving AP MLD for roaming negotiation. In some embodiments, after receiving the DL BA agreement negotiation request, the non-AP MLD sends the response to accept the BA buffer size in the request for a DL BA agreement in a management frame transmitted by the non-AP MLD to the target AP MLD through the serving AP MLD for roaming negotiation. In some embodiment, the negotiation of a larger BA buffer size for the DL BA agreement between the target AP MLD and the non-AP MLD is not performed, and the BA buffer size of the DL BA agreement negotiated by the serving AP MLD is used by the target AP MLD for the DL BA agreement. In some embodiment, the negotiated larger BA buffer size for the DL BA agreement between the target AP MLD and the non-AP MLD is mapped to the same BA bitmap size as the BA buffer size of the BA agreement between the serving AP MLD and the non-AP MLD. In some embodiment, the negotiated larger BA buffer size for the BA agreement between the target AP MLD and the non-AP MLD can be mapped to the larger BA bitmap size of the BA buffer size of the BA agreement between the serving AP MLD and the non-AP MLD. In some embodiments, during the seamless roaming stage, the serving AP MLD transmits DL frames to the non-AP MLD, and the target AP MLD is not allowed to transmit the DL frames to the non-AP MLD. In some embodiments, during the DL frame draining stage, both the serving AP MLD and the target AP MLD may be allowed to transmit DL frames to the non-AP MLD. The target AP MLD uses the BA buffer size already negotiated by the serving AP MLD to transmit the DL frames. In some embodiments, the target AP MLD is not allowed to transmit the DL data frames of a BA agreement during the DL frame draining stage if the target AP MLD negotiates a larger BA buffer size for the BA agreement than the negotiated serving AP MLD’s BA buffer size for the BA agreement. In some embodiments, the target AP MLD is not allowed to transmit the DL data frames of a BA agreement during the DL frame draining stage if the larger BA buffer size of the BA agreement negotiated by the target AP MLD and the negotiated BA buffer size of the BA agreement of the serving AP MLD are mapped to the different BA bitmap size. Further, during the seamless roaming stage, the serving AP MLD transmits DL frames to the non-AP MLD. After the DL frame draining stage, the reorder buffer at the non-AP MLD is updated to the BA buffer size negotiated with the target AP MLD. The target AP MLD then uses the negotiated BA buffer size to transmit the DL frames and updates the transmit buffer size based on the BA buffer size negotiated with the target AP MLD.

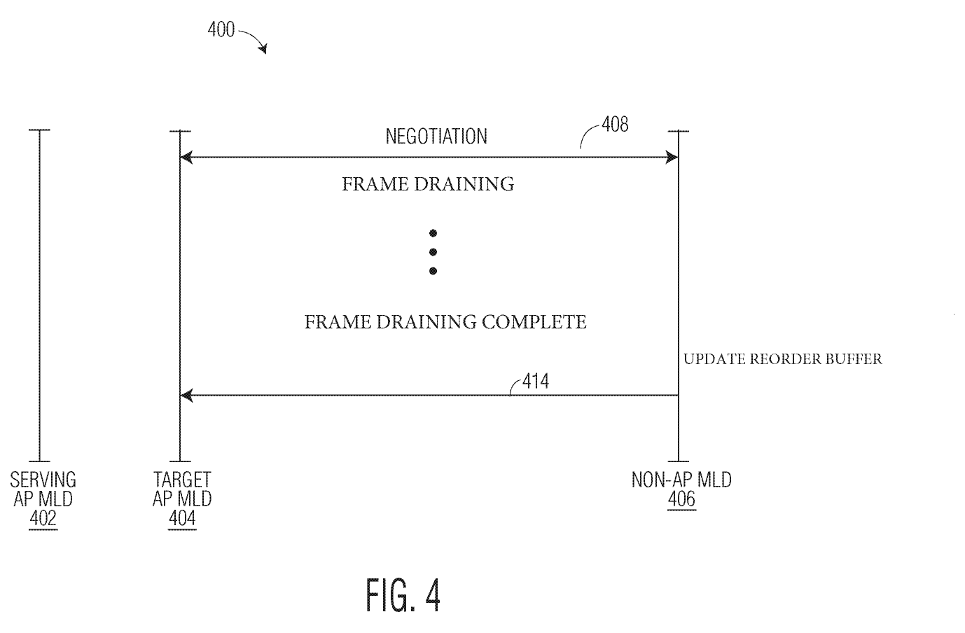

FIG. 4 illustrates example of whether to negotiate UL BA buffer size and how to negotiate the UL BA buffer size during the seamless roaming stage and uplink frame communication to the AP MLD after the DL draining stage in a seamless roaming domain (SMD) having a serving AP MLD and the target AP MLD in accordance with one or more embodiments. The UL BA buffer size may be defined by a UL BA agreement of the target AP MLD. The non-access point multi-link device 406 (non-AP MLD) may perform roaming from the serving access point multi-link device 402 (AP MLD) to the target AP MLD 404.

In one or more embodiments, the non-AP MLD 406 is not allowed to transmit UL frames to the serving AP MLD 402 and the target AP MLD 404 during the seamless roaming and the DL frame draining stage. The target AP MLD may support a reorder buffer size of a BA agreement which is smaller than the negotiated BA buffer size negotiated by the serving AP MLD for uplink communication between the non-AP MLD and the target AP MLD. At 408, the target AP MLD may negotiate with the non-AP MLD a BA agreement with a smaller BA buffer size than the BA buffer size negotiated by the serving AP MLD. The negotiated BA buffer size may be used as a transmit buffer size of the non-AP MLD and reorder buffer size of the target AP MLD for UL transmission. In some embodiments, the BA request transmitted by the non-AP MPD and BA response transmitted by the target AP MLD after receiving the request are carried in the management frames for seamless roaming negotiation. The negotiation of a BA agreement by the target AP MLD during the seamless roaming may be mandatory if target AP MLD supports a reorder buffer size of a BA agreement which is smaller than a BA buffer size negotiated by the serving AP MLD. In an embodiment, the negotiation may include the target AP MLD announcing the buffer size in the management frame for seamless roaming negotiation transmitted by the target AP MLD (Seamless Roaming Preparing Request frame) to the non-AP MLD through the serving AP MLD and the non-AP MLD accepting the buffer size. In such embodiment, the non-AP MLD does not transmit the request of BA buffer size for requesting the UL BA agreement negotiation. In some embodiments, the negotiation of a BA agreement by the target AP MLD during the seamless roaming is not allowed even if target AP MLD supports a reorder buffer size of a BA agreement which is smaller than a BA buffer size negotiated by the serving AP MLD; in such case, the target AP MLD tears down the BA agreement and announces its smaller reorder buffer size capability through the management frame for roaming negotiation. A frame draining process associated with the seamless roaming is performed and after the DL frame draining stage, the non-AP MLD is allowed to transmit the UL data frames to the target AP MLD 304 and the target AP MLD 304 is able to receive frames from the non-AP MLD 306 at 414 based on the BA agreement for UL communication. In one embodiment, the BA buffer size is replaced by the request BA buffer size of the non-AP MLD as the BA agreement originator in this paragraph.

In another embodiment, the target AP MLD 404 may support a same reorder buffer size as the BA buffer size negotiated by the serving AP MLD 402 where no UL BA agreement is negotiated during the seamless roaming stage. During the seamless roaming stage and the following DL frame draining stage, the non-AP MLD 406 is not allowed to transmit to both the serving AP MLD 402 and the target AP MLD 404 UL frames. After the DL frame draining stage, the non-AP MLD is allowed to transmit the UL data frames to the target AP MLD and the reorder buffer at the target AP MLD 404 is not changed. Alternatively, the target AP MLD 404 may support a larger reorder buffer size than the BA buffer size negotiated by the serving AP MLD 402. The target AP MLD may negotiate with the non-AP MLD a BA agreement with a larger negotiated BA buffer size than the BA buffer size negotiated by the serving AP MLD. After DL frame draining stage, the non-AP MLD 406 transmits UL frames to the target AP MLD or the non-AP MLD 406 transmits UL frames to the serving AP MLD 402 and the target AP MLD 404 based on the negotiated BA buffer size. In some embodiments, the negotiation of the new BA buffer size for a UL BA agreement is not allowed through the roaming negotiation, and the non-AP MLD 406 uses the BA buffer size negotiated by the serving AP MLD 402 for the reorder buffer of the target AP MLD 404 to transmit the UL frames. After DL frame draining stage, the non-AP MLD 406 transmits UL frames to the target AP MLD or the non-AP MLD 406 transmits UL frames to the serving AP MLD 402 and the target AP MLD 404 based on the BA buffer size already negotiated by the serving AP MLD 402 during the seamless roaming stage. After the DL frame draining stage, the reorder buffer at the target AP MLD is not changed. In one embodiment, the BA buffer size is replaced by the request BA buffer size of the non-AP MLD as the BA agreement originator in this paragraph.

In some embodiments, the target AP MLD may attempt to renegotiate a larger BA buffer size with the non-AP MLD by transmitting a Seamless Roaming Preparing Response with the response BA buffer size which is not more than a requested BA buffer size transmitted by the non-AP MLD when negotiating the UL BA agreement with the serving AP MLD. In some embodiments, a non-AP MLD may attempt to renegotiate a larger BA buffer size with the target AP MLD by transmitting a BA request with the requested BA buffer size during the seamless roaming negotiation, and the target AP MLD transmits the BA response to decide whether the request is accepted during the roaming negotiation. The requested BA buffer size may be carried in a roaming preparation request frame sent to the target AP MLD during a roaming negotiation. The BA response may be carried in a roaming preparation response frame sent to the non-AP MLD during a roaming negotiation. When the target AP MLD (as the recipient of the BA agreement) supports the smaller BA buffer size of a BA agreement compared to the BA buffer of the serving AP MLD because of the device capability restriction, the BA agreement with the target AP MLD will have the smaller negotiated BA buffer size than the serving AP per the BA negotiation. The non-AP MLD’s request to negotiate the larger BA buffer size is ignored. Further, the request is ignored when the target AP MLD (as the originator of the BA agreement) supports the same buffer size of a BA agreement of the serving AP MLD because of the device capability restriction. If the target AP MLD (as the originator of the BA agreement) supports a larger BA buffer size of a BA agreement of the serving AP MLD, then the BA buffer of the target AP MLD is no larger than that requested by the non-AP MLD. In one embodiment, the BA buffer size is replaced by the request BA buffer size of the non-AP MLD as the BA agreement originator in this paragraph.

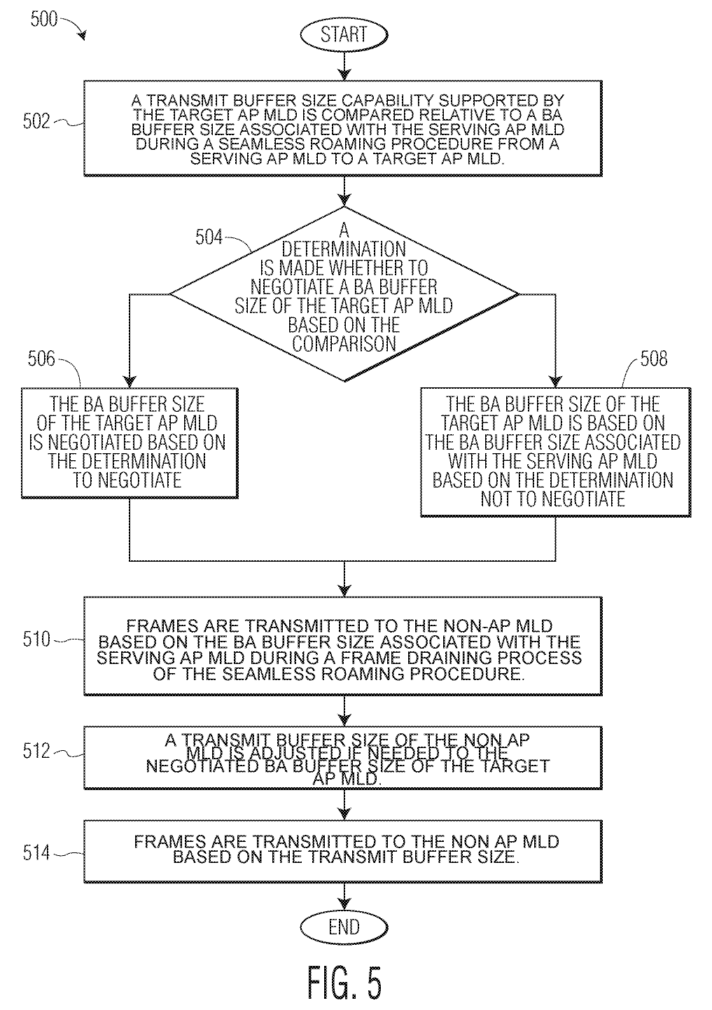

FIG. 5 illustrates a flowchart 500 of functions associated with managing a BA buffer size during seamless roaming from a serving access point multi-link device (AP MLD) to a target AP MLD and downlink communication in accordance with one or more embodiments. Disclosed functions of the flowchart 500 may be performed by the target AP MLD in an embodiment.

At 502, a transmit buffer size capability supported by the target AP MLD is compared relative to a BA buffer size associated with the serving AP MLD during a seamless roaming procedure from a serving AP MLD to a target AP MLD. At 504, a determination is made whether to negotiate a BA buffer size of the target AP MLD based on the comparison. At 506, the BA buffer size of the target AP MLD is negotiated based on the determination to negotiate. At 508, the BA buffer size of the target AP MLD is based on the BA buffer size associated with the serving AP MLD based on the determination not to negotiate. At 510, frames are transmitted to the non-AP MLD based on the BA buffer size associated with the serving AP MLD during a frame draining process of the seamless roaming procedure. At 512, a transmit buffer size of the target AP MLD is adjusted if needed to the negotiated BA buffer size of the target AP. The adjustment is performed if the transmit buffer size of the target AP MLD is not the same as a negotiated BA buffer size. At 514, frames are transmitted to the non-AP MLD based on the transmit buffer size.

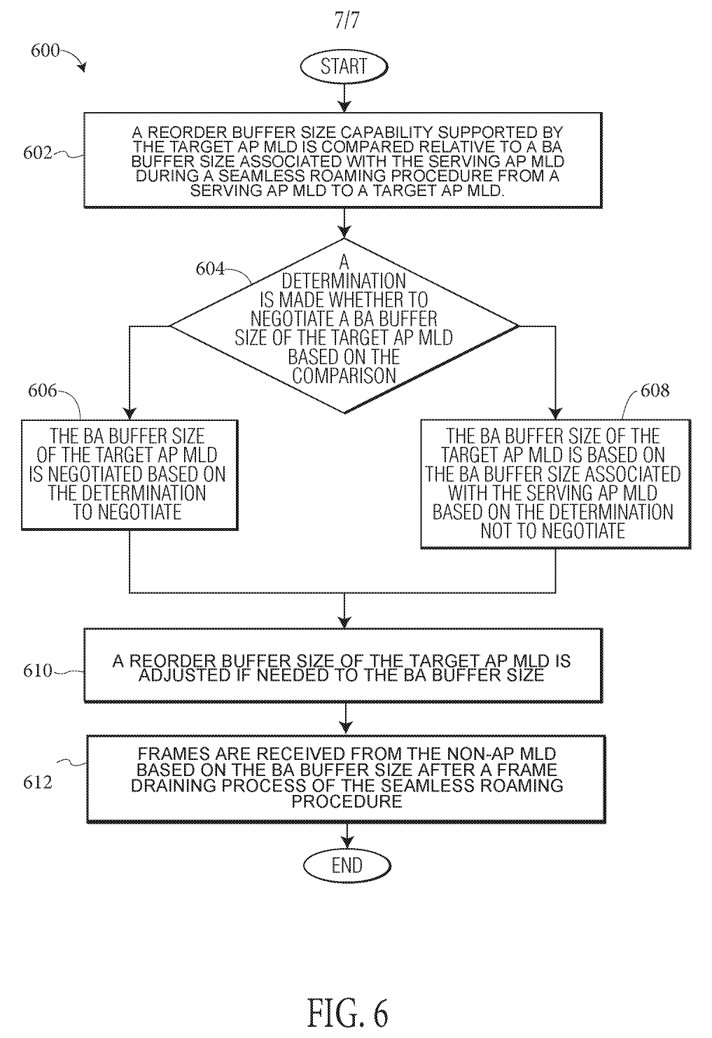

FIG. 6 illustrates a flowchart 600 of functions associated with managing a BA buffer size during seamless roaming from a serving access point multi-link device (AP MLD) to a target AP MLD and uplink communication in accordance with one or more embodiments. Disclosed functions of the flowchart 600 may be performed by the target AP MLD in an embodiment.

At 602, a reorder buffer size capability supported by the target AP MLD is compared relative to a BA buffer size associated with the serving AP MLD during a seamless roaming procedure from a serving AP MLD to a target AP MLD. At 604, a determination is made whether to negotiate a BA buffer size of the target AP MLD based on the comparison. At 606, the BA buffer size of the target AP MLD is negotiated based on the determination to negotiate. At 608, the BA buffer size of the target AP MLD is based on the BA buffer size associated with the serving AP MLD based on the determination not to negotiate. At 610, a reorder buffer size of the target AP MLD is adjusted if needed to the BA buffer size. The adjustment is performed if the BA buffer of the target AP MLD is not the same as a negotiated BA buffer size. At 612, frames are received from the non-AP MLD based on the BA buffer size after a frame draining process of the seamless roaming procedure.

In one embodiment, a method performed by a target access point (AP) multi-link device (MLD) during seamless roaming of a non-AP MLD from a serving AP MLD to the target AP MLD is disclosed. The method comprises: obtaining an indication of an uplink (UL) and downlink (DL) block acknowledgment (BA) agreement between the serving AP MLD and the non-AP MLD; determining, based on a transmit buffer size capability of the target AP MLD relative to a negotiated BA buffer size of the downlink (DL) BA agreement, whether to negotiate with the non-AP MLD a BA buffer size for a DL BA agreement with the target AP MLD, and when the determining indicates that negotiation is to be performed, negotiating the BA buffer size for the DL BA agreement between the target AP MLD and the non-AP MLD; and determining, based on a reorder buffer size capability of the target AP MLD relative to a negotiated BA buffer size of the UL BA agreement, whether to negotiate with the non-AP MLD a BA buffer size for an UL BA agreement with the target AP MLD, and when the determining indicates that negotiation is to be performed, negotiating the BA buffer size with the non-AP MLD for the UL BA agreement between the target AP MLD and the non-AP MLD. In one or more embodiments, for the UL BA agreement with the target AP MLD, the target AP MLD indicates the BA buffer size that is accepted by the non-AP MLD. In one or more embodiments, the BA buffer size for the UL BA agreement with the target AP MLD is not more than the negotiated BA buffer size of the UL BA agreement with the serving AP MLD. In one or more embodiments, the BA buffer size for the UL BA agreement with the target AP MLD is not more than a requested BA buffer size by the non-AP MLD based on the UL BA agreement with the serving AP MLD. In one or more embodiments, the BA buffer size for the UL BA agreement with the target AP MLD is used after a DL frame draining stage. In one or more embodiments, for the DL BA agreement with the target AP MLD, the target AP MLD indicates the BA buffer size that is accepted by the non-AP MLD which is no more than the BA buffer size of the DL BA agreement with the serving AP MLD. In one or more embodiments, for the DL BA agreement with the target AP MLD, the target AP MLD negotiates the BA buffer size which is more than the BA buffer size of the DL BA agreement with the serving AP MLD. In one or more embodiments, the non-AP MLD sends a requested BA buffer size to the target AP MLD, and the target AP MLD sends the BA buffer size for the DL BA agreement with the target AP MLD to the non-AP MLD during the seamless roaming. In one or more embodiments, the target AP MLD transmits DL frames within a DL frame draining stage by using the DL BA agreement with the serving AP MLD. In one or more embodiments, the target AP MLD supports a BA bitmap mapped by the BA buffer size of the DL BA agreement with the serving AP MLD. In one or more embodiments after a DL frame draining stage, the target AP MLD uses the BA buffer size of the DL BA agreement with the target AP MLD for a transmit buffer size of the DL BA agreement with the target AP MLD. In one or more embodiments, after a DL frame draining stage, the target AP MLD uses the BA buffer size of the UL BA agreement with the target AP MLD for a reorder buffer size of the UL BA agreement with the target AP MLD.

In another embodiment, a target access point (AP) multi-link device (MLD) is disclosed. The AP MLD comprises wireless interface circuitry configured to exchange frames with a non-AP MLD in a seamless roaming; and control circuitry configured to: obtain an indication of an uplink (UL) and downlink (DL) block acknowledgment (BA) agreement between a serving AP MLD and the non-AP MLD; determine, based on a transmit buffer size capability of the target AP MLD relative to a negotiated BA buffer size of the downlink (DL) BA agreement, whether to negotiate with the non-AP MLD a BA buffer size for a DL BA agreement with the target AP MLD, and when the determining indicates that negotiation is to be performed, negotiate the BA buffer size for the DL BA agreement between the target AP MLD and the non-AP MLD; and determine, based on a reorder buffer size capability of the target AP MLD relative to a negotiated BA buffer size of the UL BA agreement, whether to negotiate with the non-AP MLD a BA buffer size for an UL BA agreement with the target AP MLD, and when the determining indicates that negotiation is to be performed, negotiate the BA buffer size with the non-AP MLD for the UL BA agreement between the target AP MLD and the non-AP MLD. In one or more embodiments, for the UL BA agreement with the target AP MLD, the target AP MLD indicates the BA buffer size that is accepted by the non-AP MLD. In one or more embodiments, the BA buffer size for the UL BA agreement with the target AP MLD is not more than the negotiated BA buffer size of the UL BA agreement with the serving AP MLD. In one or more embodiments, the BA buffer size for the UL BA agreement with the target AP MLD is not more than a requested BA buffer size by the non-AP MLD based on the UL BA agreement with the serving AP MLD. In one or more embodiments, the BA buffer size for the UL BA agreement with the target AP MLD is used after a DL frame draining stage. In one or more embodiments, for the DL BA agreement with the target AP MLD, the target AP MLD indicates the BA buffer size that is accepted by the non-AP MLD which is no more than the BA buffer size of the DL BA agreement with the serving AP MLD. In one or more embodiments, for the DL BA agreement with the target AP MLD, the target AP MLD negotiates the BA buffer size which is more than the BA buffer size of the DL BA agreement with the serving AP MLD. In one or more embodiments, the non-AP MLD sends a requested BA buffer size to the target AP MLD, and the target AP MLD sends the BA buffer size for the DL BA agreement with the target AP MLD to the non-AP MLD during the seamless roaming. In one or more embodiments, the target AP MLD transmits DL frames within a DL frame draining stage by using the DL BA agreement with the serving AP MLD. In one or more embodiments, the target AP MLD supports a BA bitmap mapped by the BA buffer size of the DL BA agreement with the serving AP MLD. In one or more embodiments, after a DL frame draining stage, the target AP MLD uses the BA buffer size of the DL BA agreement with the target AP MLD for a transmit buffer size of the DL BA agreement with the target AP MLD. In one or more embodiments, after a DL frame draining stage, the target AP MLD uses the BA buffer size of the UL BA agreement with the target AP MLD for a reorder buffer size of the UL BA agreement with the target AP MLD.

The foregoing disclosure provides illustration and description but is not intended to be exhaustive or to limit the aspects to the precise form disclosed. Modifications and variations may be made in light of the above disclosure or may be acquired from practice of the aspects.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method performed by a target access point (AP) multi-link device (MLD) during seamless roaming of a non-AP MLD from a serving AP MLD to the target AP MLD, the method comprising:
obtaining an indication of an uplink (UL) and downlink (DL) block acknowledgment (BA) agreement between the serving AP MLD and the non-AP MLD;
determining, based on a transmit buffer size capability of the target AP MLD relative to a negotiated BA buffer size of the downlink (DL) BA agreement, whether to negotiate with the non-AP MLD a BA buffer size for a DL BA agreement with the target AP MLD, and when the determining indicates that negotiation is to be performed, negotiating the BA buffer size for the DL BA agreement between the target AP MLD and the non-AP MLD; and
determining, based on a reorder buffer size capability of the target AP MLD relative to a negotiated BA buffer size of the UL BA agreement, whether to negotiate with the non-AP MLD a BA buffer size for an UL BA agreement with the target AP MLD, and when the determining indicates that negotiation is to be performed, negotiating the BA buffer size with the non-AP MLD for the UL BA agreement between the target AP MLD and the non-AP MLD.

2. The method of claim 1, wherein for the UL BA agreement with the target AP MLD, the target AP MLD indicates the BA buffer size that is accepted by the non-AP MLD.

3. The method of claim 2, wherein the BA buffer size for the UL BA agreement with the target AP MLD is not more than the negotiated BA buffer size of the UL BA agreement with the serving AP MLD.

4. The method of claim 2, wherein the BA buffer size for the UL BA agreement with the target AP MLD is not more than a requested BA buffer size by the non-AP MLD based on the UL BA agreement with the serving AP MLD.

5. The method of claim 1, wherein the BA buffer size for the UL BA agreement with the target AP MLD is used after a DL frame draining stage.

6. The method of claim 1, wherein for the DL BA agreement with the target AP MLD, the target AP MLD indicates the BA buffer size that is accepted by the non-AP MLD which is no more than the BA buffer size of the DL BA agreement with the serving AP MLD.

7. The method of claim 1, wherein for the DL BA agreement with the target AP MLD, the target AP MLD negotiates the BA buffer size which is more than the BA buffer size of the DL BA agreement with the serving AP MLD .

8. The method of claim 7, wherein the non-AP MLD sends a requested BA buffer size to the target AP MLD, and the target AP MLD sends the BA buffer size for the DL BA agreement with the target AP MLD to the non-AP MLD during the seamless roaming.

9. The method of claim 6, wherein the target AP MLD transmits DL frames within a DL frame draining stage by using the DL BA agreement with the serving AP MLD.

10. The method of claim 9, wherein the target AP MLD supports a BA bitmap mapped by the BA buffer size of the DL BA agreement with the serving AP MLD.

11. The method of claim 1, wherein after a DL frame draining stage, the target AP MLD uses the BA buffer size of the DL BA agreement with the target AP MLD for a transmit buffer size of the DL BA agreement with the target AP MLD.

12. The method of claim 1, wherein after a DL frame draining stage, the target AP MLD uses the BA buffer size of the UL BA agreement with the target AP MLD for a reorder buffer size of the UL BA agreement with the target AP MLD.

13. A target access point (AP) multi-link device (MLD) comprising:
wireless interface circuitry configured to exchange frames with a non-AP
MLD in a seamless roaming; and
control circuitry configured to:
obtain an indication of an uplink (UL) and downlink (DL) block acknowledgment (BA) agreement between a serving AP MLD and the non-AP MLD;
determine, based on a transmit buffer size capability of the target AP MLD relative to a negotiated BA buffer size of the downlink (DL) BA agreement, whether to negotiate with the non-AP MLD a BA buffer size for a DL BA agreement with the target AP MLD, and when the determining indicates that negotiation is to be performed, negotiate the BA buffer size for the DL BA agreement between the target AP MLD and the non-AP MLD; and
determine, based on a reorder buffer size capability of the target AP MLD relative to a negotiated BA buffer size of the UL BA agreement, whether to negotiate with the non-AP MLD a BA buffer size for an UL BA agreement with the target AP MLD, and when the determining indicates that negotiation is to be performed, negotiate the BA buffer size with the non-AP MLD for the UL BA agreement between the target AP MLD and the non-AP MLD.

14. The target AP MLD of claim 13, wherein for the UL BA agreement with the target AP MLD, the target AP MLD indicates the BA buffer size that is accepted by the non-AP MLD.

15. The target AP MLD of claim 14, wherein the BA buffer size for the UL BA agreement with the target AP MLD is not more than the negotiated BA buffer size of the UL BA agreement with the serving AP MLD.

16. The target AP MLD of claim 14, wherein the BA buffer size for the UL BA agreement with the target AP MLD is not more than a requested BA buffer size by the non-AP MLD based on the UL BA agreement with the serving AP MLD.

17. The target AP MLD of claim 16, wherein the BA buffer size for the UL BA agreement with the target AP MLD is used after a DL frame draining stage.

18. The target AP MLD of claim 13, wherein for the DL BA agreement with the target AP MLD, the target AP MLD indicates the BA buffer size that is accepted by the non-AP MLD which is no more than the BA buffer size of the DL BA agreement with the serving AP MLD.

19. The target AP MLD of claim 13, wherein for the DL BA agreement with the target AP MLD, the target AP MLD negotiates the BA buffer size which is more than the BA buffer size of the DL BA agreement with the serving AP MLD.

20. The target AP MLD of claim 19, wherein the non-AP MLD sends a requested BA buffer size to the target AP MLD, and the target AP MLD sends the BA buffer size for the DL BA agreement with the target AP MLD to the non-AP MLD during the seamless roaming.

21. The target AP MLD of claim 13, wherein the target AP MLD transmits DL frames within a DL frame draining stage by using the DL BA agreement with the serving AP MLD.

22. The target AP MLD of claim 13, wherein the target AP MLD supports a BA bitmap mapped by the BA buffer size of the DL BA agreement with the serving AP MLD.

23. The target AP MLD of claim 13, wherein after a DL frame draining stage, the target AP MLD uses the BA buffer size of the DL BA agreement with the target AP MLD for a transmit buffer size of the DL BA agreement with the target AP MLD.

24. The target AP MLD of claim 13, wherein after a DL frame draining stage, the target AP MLD uses the BA buffer size of the UL BA agreement with the target AP MLD for a reorder buffer size of the UL BA agreement with the target AP MLD.
